(19) United States
(12) Patent Application Publication
(10) Pub. No.: US 2023/0211671 A1
(43) Pub. Date: Jul. 6, 2023

(54) APPARATUS AND METHOD OF REDUCING VIBRATION OF ELECTRIC VEHICLE

(71) Applicants: Hyundai Motor Company, Seoul (KR); Kia Corporation, Seoul (KR)

(72) Inventor: Woo Cheol CHO, Hwaseong-Si (KR)

(73) Assignees: Hyundai Motor Company, Seoul (KR); Kia Corporation, Seoul (KR)

(21) Appl. No.: 17/949,913

(22) Filed: Sep. 21, 2022

(30) Foreign Application Priority Data
Dec. 31, 2021 (KR) 10-2021-0194360

(51) Int. Cl. B60L 15/20

(52) U.S. Cl. CPC B60L 15/20; B60L 2240/423; B60L 2240/421; B60L 2240/12; B60L 2240/642

(57) ABSTRACT

An apparatus and a method of reducing vibration of an electric vehicle capable of effectively reducing vibration by applying a drivetrain torsion speed during anti jerk control to extract a vibration-induced portion and processing the vibration-induced portion to generate a final output torque, include a drivetrain torsion speed calculator, a motor speed calculator, a model speed calculator, a vibration-induced portion calculator, a high-pass filter, a phase delay unit, and an anti jerk compensation torque generator.

### CROSS-REFERENCE TO RELATED APPLICATION

The present application claims priority to Korean Patent Application No. 10-2021-0194360, filed on Dec. 31, 2021, the entire contents of which is incorporated herein for all purposes by this reference.

### BACKGROUND OF THE PRESENT DISCLOSURE

### Field of the Present Disclosure

The present disclosure relates to a system for reducing vibration of an electric vehicle, and more particularly, to an apparatus and a method of reducing vibration of an electric vehicle capable of effectively reducing vibration by applying a drivetrain torsion speed during anti jerk control to extract a vibration-induced portion and processing the vibration-induced portion to generate a final output torque.

### Description of Related Art

A vehicle that utilizes a motor as power, such as an electric vehicle, reduces vibration of the same through anti jerk control of the motor. Here, “jerk” is a vector specifying the change rate in acceleration over time.

To reduce vibration of the electric vehicle, a vibration-induced portion of the electric vehicle may be accurately extracted first, and a conventional apparatus of reducing vibration extracts the vibration-induced portion by use of the difference between a motor speed and a model speed. Here, the motor speed means the actual speed of the motor, and the model speed means the speed of the motor modeled assuming that there is no vibration generated by operation of the motor. The vibration-induced portion extracted using the difference between the motor speed and the model speed is passed through a high-pass filter (HPF) to remove an error component included in the vibration-induced portion. Thereafter, the phase of the vibration-induced portion that has been passed through the high-pass filter is delayed, and then an anti-jerk torque, obtained by applying a predetermined gain, is applied to a driver demand torque to thereby reduce vibration. In the present method, vibration may be effectively reduced while the electric vehicle travels at a constant speed.

When the electric vehicle accelerates or decelerates, the torque of a driving motor changes, and at the instant time, torsion of the drivetrain occurs. Because the conventional vibration reduction system extracts the torsion of the drivetrain that occurs at the instant time as a vibration-induced portion, when the vibration-induced portion is processed and applied to the torque of the driving motor, the vibration is exacerbated.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and a method of reducing vibration of an electric vehicle that substantially obviate one or more problems due to limitations and disadvantages of the related art.

Various aspects of the present disclosure are directed to providing an apparatus of reducing vibration of an electric vehicle configured for effectively reducing vibration by applying a drivetrain torsion speed during anti-jerk control to extract a vibration-induced portion and processing the vibration-induced portion to generate a final output torque.

Various aspects of the present disclosure are directed to providing a method of reducing vibration of an electric vehicle configured for effectively reducing vibration by applying a drivetrain torsion speed during anti jerk control to extract a vibration-induced portion and processing the vibration-induced portion to generate a final output torque.

Additional advantages, objects, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure particularly pointed out in the written description and claims hereof as well as the appended drawings.

To achieve these objects and other advantages and in accordance with the present disclosure, as embodied and broadly described herein, provided is an apparatus of reducing vibration of an electric vehicle, the apparatus including a drivetrain torsion speed calculator, a motor speed calculator, a model speed calculator, a vibration-induced portion calculator, a high-pass filter, a phase delay unit, and an anti-jerk compensation torque generator.

The drivetrain torsion speed calculator may determine a drivetrain torsion speed, which is generated when the electric vehicle accelerates or decelerates. The motor speed calculator may determine at least one of a motor speed, which is an actual speed of a motor of the electric vehicle, and a corrected motor speed including the drivetrain torsion speed applied to the motor speed. The model speed calculator may determine at least one of a model speed of the motor, which is modeled assuming that there is no vibration generated in the motor, and a corrected model speed including the drivetrain torsion speed applied to the model speed. The vibration-induced portion calculator may determine a vibration-induced portion using the motor speed, the corrected motor speed, the model speed, and the corrected model speed. The high-pass filter may remove an error component included in the vibration-induced portion. The phase delay unit may delay the phase of the vibration-induced portion passing through the high-pass filter. The anti jerk compensation torque generator may generate an anti jerk compensation torque by applying a predetermined gain value to the phase-delayed vibration-induced portion.

In one aspect of the present disclosure, provided is a method of reducing vibration of an electric vehicle, the method including accelerating or decelerating the electric vehicle, determining a motor speed of the electric vehicle during travel, determining the drivetrain torsion speed using an output torque of the motor of the electric vehicle, a torsion coefficient of a driveshaft of the vehicle, and a torsion angle of the driveshaft, determining a model speed of the electric vehicle and determining a corrected model speed including the drivetrain torsion speed applied to the model speed, determining a vibration-induced portion using the motor speed and the corrected model speed, reducing an error component included in the vibration-induced portion, generating a phase-delayed vibration-induced portion in which the phase of the vibration-induced portion including a reduced error component is delayed, and generating an anti jerk torque by applying a predetermined gain value to the vibration-induced portion.

In another aspect of the present disclosure, provided is a method of reducing vibration of an electric vehicle, the method including accelerating or decelerating the electric vehicle, determining a motor speed of the electric vehicle in traveling, determining the drivetrain torsion speed using an output torque of the motor of the electric vehicle, a torsion coefficient of a driveshaft of the vehicle, and a torsion angle of the driveshaft, determining a corrected motor speed including the drivetrain torsion speed applied to the motor speed, determining a model speed of the electric vehicle, determining a vibration-induced portion using the corrected motor speed and the model speed, reducing an error component included in the vibration-induced portion, generating a phase-delayed vibration-induced portion in which the phase of the vibration-induced portion including a reduced error component is delayed, and generating an anti jerk torque by applying a predetermined gain value to the vibration-induced portion.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is an exemplary embodiment of an apparatus of reducing vibration of an electric vehicle according to an exemplary embodiment of the present disclosure;

FIG. 2 illustrates a method of applying a drivetrain torsion speed to a model speed or a motor speed;

FIG. 3 is an exemplary embodiment of a method of reducing vibration of an electric vehicle according to an exemplary embodiment of the present disclosure;

FIG. 4 is another exemplary embodiment of a method of reducing vibration of an electric vehicle according to an exemplary embodiment of the present disclosure; and

FIG. 5 is a comparison of performance results of the method according to the related art and the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

To fully understand the present disclosure, the operational advantages of the present disclosure, and the objects achieved by the practice of the present disclosure, reference should be made to the accompanying drawings describing exemplary embodiments of the present disclosure and the contents describing the accompanying drawings.

A description will now be provided in detail of the exemplary embodiments disclosed herein with reference to the accompanying drawings. Like reference numerals in each drawing indicate like members.

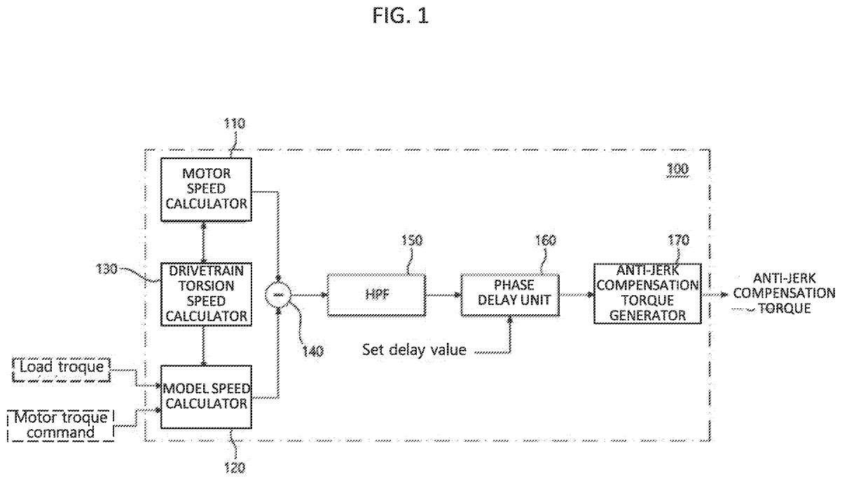

FIG. 1 is an exemplary embodiment of an apparatus of reducing vibration of an electric vehicle according to an exemplary embodiment of the present disclosure.

Referring to FIG. 1, an apparatus 100 for reducing vibration of an electric vehicle (EV) according to an exemplary embodiment of the present disclosure includes a motor speed calculator 110, a model speed calculator 120, a drivetrain torsion speed calculator 130, a vibration-induced portion calculator 140, a high-pass filter 150, a phase delay unit 160, and an anti-jerk compensation torque generator 170.

In various exemplary embodiments of the present disclosure, the apparatus 100 can be configured by a controller.

The motor speed calculator 110 determines the motor speed, which is the actual rotation speed of a motor. The motor speed output from the motor speed calculator 110 may be a simple motor speed A. However, the motor speed may also be a corrected motor speed A′ in which a drivetrain torsion speed, determined by the drivetrain torsion speed calculator 130, which is to be described later, is subtracted from the simple motor speed A.

The model speed calculator 120 determines the model speed of the motor based on the motor torque command, load torque, gear shifting information, traveling status, wheel speed, transmission input/output speed, vehicle mode, and the like. Here, the load torque may include road slope, aerodynamic drag, etc., the traveling status may include tip-in/tip-out, brake shift, etc., and the vehicle mode may include EV mode, Hybrid EV mode, engine clutch slip, etc. The model speed output from the model speed calculator 120 may be a simple model speed B. However, the model speed may also be a corrected model speed B′ in which a drivetrain torsion speed, determined by the drivetrain torsion speed calculator 130, which is to be described later, is added to the simple model speed B.

The drivetrain torsion speed calculator 130 determines a drivetrain torsion speed which is generated when the electric vehicle accelerates or decelerates. The method of determining the drivetrain torsion speed will be described later. As described above, one of the core ideas of the present disclosure is to correct the drivetrain torsion speed by subtracting the same from the motor speed or adding the same to the model speed to apply the corrected drivetrain torsion speed to the vibration-induced portion.

The vibration-induced portion calculator 140 determines a vibration-induced portion based on the difference between a motor speed or a corrected motor speed determined by the motor speed calculator 110 and a model speed or a corrected model speed determined by the model speed calculator 120. The drivetrain torsion speed is applied to the vibration-induced portion by, for example, using the difference between the motor speed A and the corrected model speed B′ or the difference between the corrected motor speed A′ and the model speed B.

The high-pass filter 150 removes an error component included in the vibration-induced portion determined by the vibration-induced portion calculator 140.

The phase delay unit 160 delays the phase of the vibration-induced portion according to a set delay value to compensate for a phase antecedence generated while the vibration-induced portion passes through the high-pass filter 150.

The anti jerk compensation torque generator 160 generates an anti jerk compensation torque (AJT) by applying a predetermined gain value to a vibration-induced portion, the phase of which is delayed according to a set delay value. Here, the gain value is a value generated based on the traveling mode, gear shifting information, and the traveling status of the electric vehicle.

In an exemplary embodiment of the present disclosure, the drivetrain torsion speed is applied to the vibration-induced portion to generate an anti-jerk torque, and then the motor is operated using a final output torque generated by adding the anti-jerk torque to a driver demand torque, effectively reducing vibration which may occur in the electric vehicle.

The process of determining the torsion speed of the drivetrain is as follows.

An output torque T of the motor may be expressed as in Equation 1.

T=k·θ[Equation1]

In Equation 1, k is a torsion coefficient of the driveshaft of the electric vehicle, and θ is a torsion angle of the driveshaft.

When Equation 1 is differentiated, the speed of the torsion angle of the driveshaft \dot{θ} may be determined using Equation 2.

$$\frac{dT}{d t} = k \cdot \frac{d θ}{dt} \qquad [ Equation 2 ]$$

$$\dot{θ} = \frac{d θ}{dt} = \frac{d T}{dt} \cdot \frac{1}{k}$$

Referring to Equation 2, it may be seen that the speed of the torsion angle of the driveshaft (\dot{θ}, hereinafter, the drivetrain torsion speed) is a value obtained by multiplying the differential value dT/dt of the torque of the motor by the reciprocal 1/k of the torsion coefficient of the driveshaft. Because the torsion coefficient k of the driveshaft is a known value and the differential value of the torque of the motor, that is, the change rate in the torque over time dT/dt may be determined in real time, the drivetrain torsion speed may be easily determined.

In an exemplary embodiment of the present disclosure, as shown in Equation 2, it is provided to apply the speed of the torsion angle of the driveshaft, that is, the torsion speed of the drivetrain, to the model speed or the motor speed to improve the performance of removing vibration.

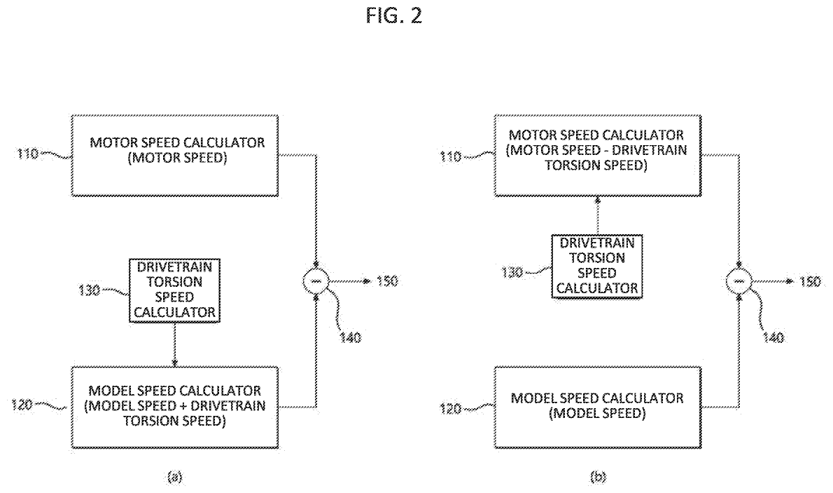

FIG. 2 illustrates a method of applying the drivetrain torsion speed to the model speed or to the motor speed.

Referring to FIG. 2A, the drivetrain torsion speed is added to the model speed when the drivetrain torsion speed is applied to the model speed, and referring to FIG. 2B, the drivetrain torsion speed is subtracted from the motor speed when the drivetrain torsion speed is applied to the motor speed.

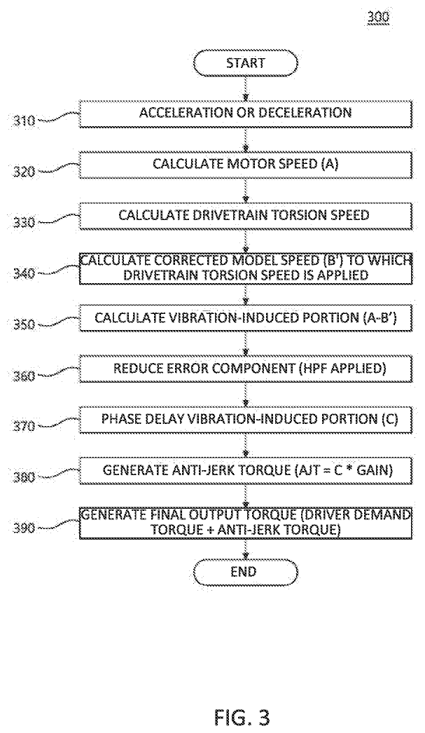

FIG. 3 is an exemplary embodiment of a method of reducing vibration of an electric vehicle according to an exemplary embodiment of the present disclosure.

Referring to FIG. 3, a method 300 of reducing vibration of the electric vehicle includes accelerating or decelerating the electric vehicle in step 310, determining a motor speed A of the electric vehicle while traveling in step 320, determining a drivetrain torsion speed in step 330, determining a corrected model speed B′ to which the drivetrain torsion speed is applied in step 340, determining a vibration-induced portion in step 350, reducing an error component (e.g., noise induced by a drivetrain torsion) from the vibration-induced portion in step 360, generating a phase-delayed vibration-induced portion C in step 370, generating an anti jerk torque (AJT) in step 380, and generating a final output torque in step 390.

The method 300 of reducing vibration shown in FIG. 3 may be performed by the apparatus 100 for reducing vibration shown in FIG. 1, and will be described below based on the present idea.

In the accelerating or decelerating the electric vehicle in step 310, the electric vehicle is accelerated or decelerated so that torsion of the driveshaft, which does not occur while traveling at a constant speed, occurs.

In the determining the motor speed A of the electric vehicle while traveling in step 320, the motor speed calculator 110 determines the motor speed A of the electric vehicle accelerating or decelerating.

In the determining the drivetrain torsion speed in step 330, the drivetrain torsion speed calculator 130 determines the drivetrain torsion speed using an output torque of the motor, a torsion coefficient of the driveshaft of the electric vehicle, and a torsion angle of the driveshaft. Because the determination process and equations have been described above, a description thereof will be omitted here.

In the determining the corrected model speed B′ to which the drivetrain torsion speed is applied in step 340, the model speed calculator 120 adds the drivetrain torsion speed determined in the determining the drivetrain torsion speed in step 330 to the predetermined model speed B to obtain a corrected model speed B′.

In the determining the vibration-induced portion in step 350, the vibration-induced portion calculator 140 determines the vibration-induced portion using the difference A-B′ between the motor speed A and the corrected model speed B′.

In the reducing the error component from the vibration-induced portion in step 360, the high-pass filter 150 passes the vibration-induced portion determined in the determining the vibration-induced portion in step 350 through the high-pass filter 150 to reduce an error component included in the vibration-induced portion.

In the generating a phase-delayed vibration-induced portion C in step 370, to remove the phase antecedence generated in a process of passing the vibration-induced portion through the high-pass filter 150 and included in the vibration-induced portion, the phase delay unit 160 delays C the phase of the vibration-induced portion according to a set delay value.

In the generating the anti jerk torque (AJT) in step 380, the anti-jerk compensation torque generator 170 generates an anti-jerk torque (AJT) by applying a predetermined gain to the phase-delayed vibration-induced portion.

In the generating a final output torque in step 390, a final output torque is generated by adding the anti-jerk torque to a driver demand torque.

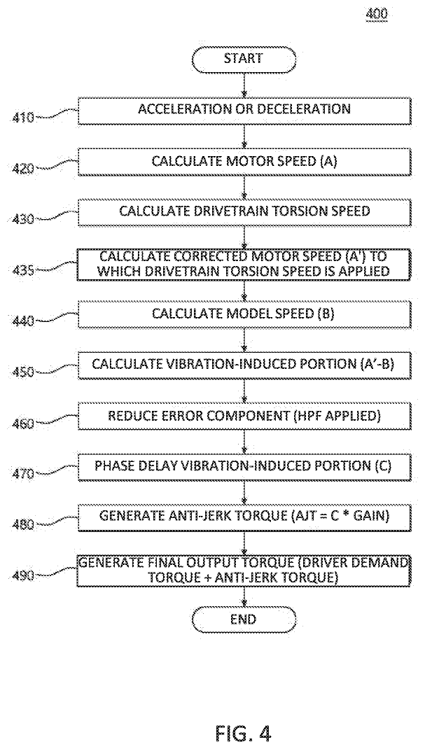

FIG. 4 is another exemplary embodiment of a method of reducing vibration of an electric vehicle according to an exemplary embodiment of the present disclosure.

Referring to FIG. 4, a method 400 of reducing vibration of the electric vehicle includes accelerating or decelerating the electric vehicle in step 410, determining a motor speed A of the electric vehicle during traveling in step 420, determining a drivetrain torsion speed in step 430, determining a corrected motor speed A′ to which the drivetrain torsion speed is applied in step 435, determining a model speed B in step 440, determining a vibration-induced portion in step 450, reducing an error component (e.g., noise induced by a drivetrain torsion) from the vibration-induced portion in step 460, generating a phase-delayed vibration-induced portion C in step 470, generating an anti jerk torque (AJT) in step 480, and generating a final output torque in step 490.

The method 400 of reducing vibration shown in FIG. 4 may also be performed by the apparatus 100 for reducing vibration shown in FIG. 1, and the idea is also reflected in the following description.

Because the only difference between the method 300 of reducing vibration shown in FIG. 3 and the method 400 of reducing vibration shown in FIG. 4 is that the drivetrain torsion speed is applied to the model speed in the method 300 of reducing vibration and the drivetrain torsion speed is applied to the motor speed in the method 400 of reducing vibration, only aspects of the methods that differ will be described below.

In comparison with the method 300 of reducing vibration shown in FIG. 3, it may be seen that the method 400 of reducing vibration shown in FIG. 4 further includes the determining the corrected motor speed A′ to which the drivetrain torsion speed is applied in step 435.

In the determining the corrected motor speed A′ to which the drivetrain torsion speed is applied in step 435 shown in FIG. 4, referring to FIG. 2B, the corrected motor speed A′ is a value obtained by subtracting the drivetrain torsion speed from the motor speed.

Referring to FIG. 2 and FIG. 3, it is not difficult to understand the operation shown in FIG. 4, so FIG. 4 will be omitted in detail herein.

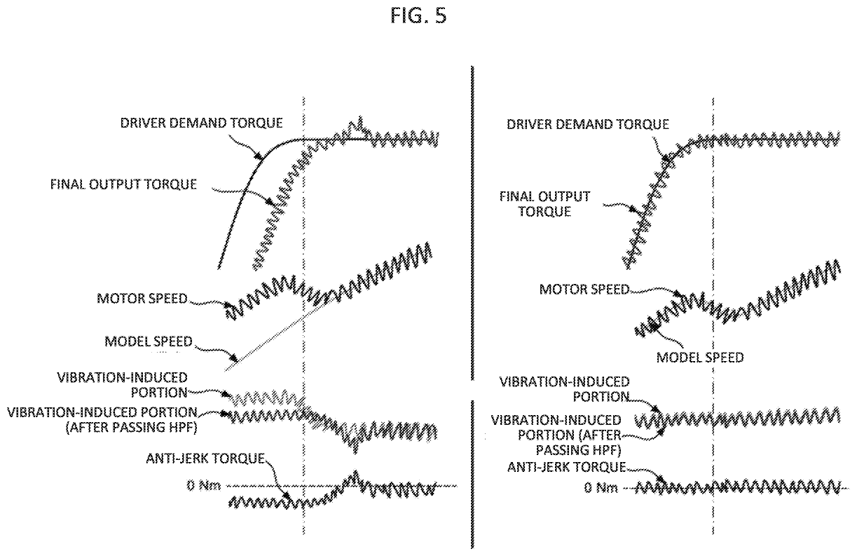

FIG. 5 is a comparison of performance results of the method according to the related art and the present disclosure.

Based on the thick vertical line shown in the center, an example of the related art is shown on the left side of FIG. 5, and the exemplary embodiment of the present disclosure is shown on the right side of FIG. 5.

In the method according to the related art shown on the left side of FIG. 5, in the section to the left of the vertical dashed-dotted line, that is, in the section in which torques increase due to acceleration, torsion of the drivetrain increases, and thus the motor speed is greater than the model speed. In contrast, in the section to the right of the vertical dashed-dotted line, that is, the section in which torque having the same magnitude is applied, the torsion of the drivetrain is maintained constant, so that the model speed and the motor speed are similar to each other.

Therefore, in the acceleration section, when the vibration-induced portion is extracted from the difference between the motor speed and the model speed, an error proportional to the difference due to the torsion of the drivetrain is included, and when the vibration-induced portion is passed through a high-pass filter to reduce the error, the error is reduced but not completely eliminated, and distortion occurs in the section in which the error changes. The vibration-induced portion that has passed through the filter is phase delayed, and is then multiplied by the gain to obtain the anti-jerk torque.

When applying the final output torque, which is the sum of the driver demand torque and the anti jerk torque, to the motor, in the method according to the related art shown on the left side of FIG. 5, referring to the section to the left of the vertical dashed-dotted line, that is, the section in which the driver demand torque increases, it may be seen that the final output torque which is applied is smaller than the driver demand torque, and referring to the section to the right of the vertical dashed-dotted line, that is, the section in which the magnitude of the driver demand torque is maintained constant, it may be seen that the final output torque momentarily exceeds the driver demand torque and causes a shock.

Referring to the exemplary embodiment of the present disclosure shown on the right side of FIG. 5, because the vibration-induced portion, in which the speed due to the torsion of the drivetrain is included in the model speed or in the motor speed, is used, the driver demand torque and the final output torque are identical to each other, the motor speed and the model speed are identical to each other, and the vibration-induced portion and a vibration-induced portion that has been passed through the high-pass filter are identical to each other, and thus the anti-jerk torque also remains uniform. Therefore, it may be seen that all of the problems occurring in the method according to the related art have been solved.

As described above, the apparatus and the method of reducing vibration of an electric vehicle are advantageous in that vibration during acceleration or deceleration of the electric vehicle is reduced to a minimum, and problems such as the final output being smaller than the driver demand torque and the final output being momentarily increased compared to the driver demand torque may be solved.

The present disclosure may be implemented as computer-readable code in media including a program recorded thereon. The computer-readable media include all kinds of recording devices in which data readable by a computer system is stored. Examples of such computer-readable media may include a Hard Disk Drive (HDD), a solid-state drive (SSD), a silicon disk drive (SDD), ROM, RAM, CD-ROM, magnetic tape, a floppy disk, an optical data storage element and the like.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard

Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus of reducing vibration of an electric vehicle (EV), the apparatus comprising:
a drivetrain torsion speed calculator configured to determine a drivetrain torsion speed which is generated when the electric vehicle is accelerated or decelerated;
a motor speed determiner configured to determine at least one of an actual motor speed and a corrected motor speed of a motor of the electric vehicle, wherein the corrected motor speed is obtained by applying the drivetrain torsion speed to the actual motor speed;
a model speed determiner configured to determine at least one of a model speed and a corrected model speed of the motor, the model speed obtained through a computational model in which it is assumed that there is no vibration generated in the motor, the corrected model speed obtained by applying the drivetrain torsion speed to the model speed;
a vibration-induced portion determiner configured to determine a vibration-induced portion among a first speed by use of the first speed and a second speed, the first speed being one of the motor speed and the corrected motor speed, the second speed being one of the model speed and the corrected model speed; and
an anti jerk compensation torque generator configured to generate an anti jerk compensation torque by applying a predetermined gain value to the vibration-induced portion.

2. The apparatus of claim 1, further including:
a filter configured to remove noise due to a drivetrain torsion from the vibration-induced portion; and
a phase delay unit configured to delay a phase of the vibration-induced portion passed through the filter and then transmit the same to the compensation torque generator.

3. The apparatus of claim 1, wherein the drivetrain torsion speed is determined by a differential of an output torque of the motor and a torsion coefficient of a driveshaft.

4. The apparatus of claim 1,
wherein the model speed is determined based on a motor torque command, a load torque, gear shifting information, a traveling status, a wheel speed, a transmission input/output speed, and an electric vehicle mode, and
wherein the load torque includes a road slope and an aerodynamic drag, the traveling status includes tip-in/tip-out and brake shift, and the electric vehicle mode includes an EV mode, an HEV mode, and engine clutch slip mode.

5. The apparatus of claim 1,
wherein the corrected motor speed is obtained by subtracting the drivetrain torsion speed from the motor speed, or
wherein the corrected model speed is obtained by adding the drivetrain torsion speed to the model speed.

6. The apparatus of claim 1, wherein the vibration-induced portion is obtained using a difference between the motor speed and the corrected model speed or a difference between the corrected motor speed and the model speed.

7. The apparatus of claim 1, wherein the gain value is generated based on a traveling mode, gear shifting information, and a traveling status of the electric vehicle.

8. A method of reducing vibration of an electric vehicle (EV) by being executed by a processor in the electric vehicle, the method including:
determining, by the processor, a motor speed of the electric vehicle;
determining, by the processor, a drivetrain torsion speed generated when the electric vehicle is accelerated or decelerated;
determining, by the processor, at least one of a model speed and a corrected model speed of the electric vehicle, the corrected model speed determined by applying the drivetrain torsion speed to the model speed;
determining, by the processor, a vibration-induced portion among the motor speed by use of the motor speed and the corrected model speed; and
generating, by the processor, an anti jerk torque by applying a predetermined gain value to the vibration-induced portion.

9. The method of claim 8, wherein the determining the drivetrain torsion speed includes determining the drivetrain torsion speed by use of an output torque of the motor of the electric vehicle, a torsion coefficient of a driveshaft of the vehicle, and a torsion angle of the driveshaft.

10. The method of claim 8, further including:
reducing, by the processor, noise due to a drivetrain torsion from the vibration-induced portion; and
generating, by the processor, a phase-delayed vibration-induced portion by delaying a phase of the vibration-induced portion from which the noise is reduced.

11. A method of reducing vibration of an electric vehicle (EV) by being executed by a processor in the electric vehicle, the method including:
determining, by the processor, a motor speed of the electric vehicle;
determining, by the processor, a drivetrain torsion speed generated when the electric vehicle is accelerated or decelerated;
determining, by the processor, a corrected motor speed by applying the drivetrain torsion speed to the motor speed;
determining, by the processor, a model speed of the electric vehicle;
determining, by the processor, a vibration-induced portion by use of the corrected motor speed and the model speed; and
generating, by the processor, an anti jerk torque by applying a predetermined gain value to the vibration-induced portion.

12. The method of claim 11, wherein the determining of the drivetrain torsion speed includes determining the drivetrain torsion speed by use of an output torque of the motor of the electric vehicle, a torsion coefficient of a driveshaft of the vehicle, and a torsion angle of the driveshaft.

13. The method of claim 11, further including:
reducing, by the processor, noise due to a drivetrain torsion from the vibration-induced portion; and
generating, by the processor, a phase-delayed vibration-induced portion by delaying a phase of the vibration-induced portion from which the noise is reduced.

14. The method of claim 8, further including generating a final output torque by adding the anti jerk torque to a driver demand torque.

15. The method of claim 8, wherein the drivetrain torsion speed is determined by use of a differential of an output torque of the motor and a torsion coefficient of a driveshaft.

16. The method of claim 8,
wherein the model speed is determined based on a motor torque command, a load torque, gear shifting information, a traveling status, a wheel speed, a transmission input/output speed, and an electric vehicle mode, and
wherein the load torque includes a road slope and an aerodynamic drag, the traveling status includes tip-in/tip-out and brake shift, and the electric vehicle mode includes an EV mode, a hybrid EV mode, and an engine clutch slip mode.

17. The method of claim 8,
wherein the corrected motor speed is obtained by subtracting the drivetrain torsion speed from the motor speed, or
wherein the corrected model speed is obtained by adding the drivetrain torsion speed to the model speed.

18. The method of claim 8, wherein the vibration-induced portion is obtained by use of a difference between the motor speed and the corrected model speed.

19. The method of claim 11, wherein the vibration-induced portion is obtained by use of a difference between the corrected motor speed and the model speed.

20. The method of claim 8, wherein the gain value is generated based on a traveling mode, gear shifting information, and a traveling status of the electric vehicle.
